(19) United States
(12) Patent Application Publication
(10) Pub. No.: US 2023/0237409 A1
(43) Pub. Date: Jul. 27, 2023

(54) AUTOMATIC COMPUTER PREDICTION OF ENTERPRISE EVENTS

(71) Applicant: REORG RESEARCH, INC., New York, NY (US)

(72) Inventors: Sreekanth Mallikarjun, Albany, NY (US); Charu Rawat, Jersey City, NJ (US)

(21) Appl. No.: 17/586,163

(22) Filed: Jan. 27, 2022

(51) Int. Cl. G06Q 10/06; G06N 20/20

(52) U.S. Cl. CPC G06Q 10/06375; G06Q 10/0635; G06N 20/20

(57) ABSTRACT

Using digital unstructured text concerning entities to generate a prediction of a risk of a change in state of one of the entities. One method comprises compiling a training dataset from distinct sets of unstructured digitally stored electronic text documents; training machine learning classifiers using the training dataset, the machine learning classifiers comprising a tree-based random forest model and a generalized linear model corresponding to each of the distinct sets, each of the machine learning classifiers being configured to classify documents based upon digital features and to output a prediction value; obtaining an evaluation dataset comprising other unstructured electronic text documents that are not in the training dataset; executing the machine learning classifiers thereby outputting individual classification outputs, which can be blended to form a final risk index score value; generating user interface presentation instructions to display visualizations of the classification outputs and/or the final risk index score value.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2021 Reorg Research, Inc.

### TECHNICAL FIELD

One technical field of the present disclosure is trained machine learning models as applied to unstructured data. Another technical field of the disclosure is computer-aided graphical visualization of machine learning output data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The ordinary daily operation of public business enterprises and the information media results in the creation and dissemination of vast amounts of regulatory filings, call transcripts, press releases, and other business documents. However, the limited human capacity to consume information, coupled with practical limits of time, make extracting meaning from this ocean of information extremely difficult. While computer-implemented search engines and document indexing are available, they only allow more rapid retrieval of relevant documents, without solving the problem of how to understand and meaning of the information or forecast its impact on other actions. The conventional use of search engines or document management systems can consume large amounts of digital storage, memory, and network bandwidth as analysts retrieve, read, and store copies of relevant documents.

Furthermore, the state of a business enterprise is not static but continuously changes. A change in state of one business enterprise can directly and profoundly impact other business decisions, risks, gains, and losses, both in public markets and in secondary instruments. To inform decisions, facilitate gains, and reduce losses, business information analysts often wish to predict the future state of a particular business enterprise based upon presently available information. In conventional practice, forecasting changes in state require intense and time-consuming studies of large volumes of information, making the forecasting error-prone and limited in accuracy.

Consequently, there is an unmet need in the information analysis field for an automated means of forecasting or predicting a change in state, or the occurrence of specified events, relating to business enterprises and institutions. There is a particular need for methods of predicting business failure, or certain kinds of business filings, using automated systems that efficiently use resources such as digital data storage, computer main memory, network bandwidth, and CPU cycles.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2 illustrates a computer-assisted process of training multiple machine learning models.

FIG. 3 illustrates a computer-implemented process of evaluating or executing multiple machine learning models in real time based upon newly obtained unstructured text documents.

FIG. 4 illustrates an example computer-generated graphical visualization of multiple predicted output values from multiple machine learning models relating to a particular enterprise.

FIG. 5A illustrates a set of highly predictive features derived from a large number of call transcript documents, in association with computer-generated box plot graphics that associate the features with an axis representing a magnitude of predictive value.

FIG. 5B, FIG. 5C, FIG. 5D, FIG. 5E each illustrate the predictive impact of specified features of specified kinds of documents including 8-K, 10-K, press releases, and transcripts, respectively, for the random forest models of FIG. 1.

FIG. 6 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in sections below according to the following outline:

1. General Overview

2. Structural & Functional Overview

3. Implementation Example—Hardware Overview

In this disclosure, the following acronyms have the following meanings: GLM=Generalized Linear Model; RFT=Random Forest Tree(s); PR=Press Release(s); TR=Transcript(s) RF=Risk Factors from 10-K, NT 10-K, 10-Q, NT 10-Q; SEC=SEC 8-K(s), 8K/A(s).

### 1. General Overview

The inventors have conceived and discovered, in an inventive moment, that machine processing of digitally stored electronic documents, in numbers beyond the human capacity to read and correlate, using machine learning models that have been trained to classify, in a broad sense, the documents in features primarily focused on measuring issues such as higher leverage in terms of equity or debt in comparison to capital or revenue, higher asset volatility, and lower growth rate, can be predictive of the high or low risk of a change in state, or the occurrence of specified events, relating to business enterprises and institutions. Examples include but are not limited to filing a petition for bankruptcy, acting in default of a covenant or other obligation, failing to receive a going concern label or note in an analyst report.

In an embodiment, a computer-implemented method of automatically processing digitally stored unstructured text concerning a plurality of entities and automatically generating a prediction of a risk of a change in state of one or more of the entities, the method comprising, executed using one or more computing devices: compiling a training dataset from two or more distinct sources of sets of unstructured digitally stored electronic text documents; training a plurality of machine learning classifiers using the training dataset, the plurality of machine learning classifiers comprising a tree-based random forest model corresponding to each of the two or more distinct sets and a generalized linear model corresponding to each of the two or more distinct sets, each of the plurality of machine learning classifiers being configured to classify input documents based upon a plurality of digital features and to output a prediction value; obtaining an evaluation dataset from the two or more distinct sources, the evaluation dataset comprising other unstructured digitally stored electronic text documents that are not in the training dataset; executing the plurality of machine learning classifiers thereby evaluating the evaluation dataset and outputting a plurality of individual classification outputs; blending the plurality of individual classification outputs to form a final risk index score value; programmatically generating a plurality of user interface presentation instructions which, when rendered using a computer display device, cause visually displaying one or more graphical visualizations of the individual classification outputs and/or the final risk index score value.

According to one feature, the plurality of machine learning classifiers comprise eight (8) machine learning models consisting of a tree-based random forest model (RFT model) configured to classify US Securities and Exchange Commission (SEC) documents of a first type; a generalized linear model (GLM) configured to classify the US Securities and Exchange Commission (SEC) documents of the first type; an RFT model configured to classify press releases; a GLM model configured to classify the press releases; an RFT model configured to classify call transcripts; a GLM model configured to classify the call transcripts; an RFT model configured to classify SEC documents of a second type; a GLM model configured to classify the SEC documents of the second type.

In another feature, the method further comprises training the plurality of machine learning classifiers using a placebo labeled training dataset comprising a plurality of digital electronic documents all associated with enterprises that did not file a petition for bankruptcy, did not act in default of a covenant or other obligation, or received a going concern designation.

In another feature, the method further comprises programmatically generating the plurality of user interface presentation instructions which, when rendered using a computer display device, cause visually displaying a radar plot, the individual classification outputs being displayed as a plurality of different points on different axes of the radar plot.

In another feature, the method further comprises programmatically generating the plurality of user interface presentation instructions which, when rendered using a computer display device, cause visually displaying a polygon having sides that join the points.

In another feature, the risk of a change in state of one or more of the entities comprises a risk of an enterprise filing a petition for bankruptcy. In another feature, the risk of a change in state of one or more entities comprises a risk of an enterprise acting in default of a covenant or other obligation or failing to receive a going concern designation.

In yet another feature, the plurality of digital features comprises, for call transcripts, credit_facil; strateg_altern; significs_reduc; covs; asset_sale, or five (5) or more of: turn_call; strateg_altern; significs_reduc; reduc_oper; reduc_cost; percentagesign_percentagesign; million_dollarsign_million; million_dollarsign; loss_dollarsign; look_statement; interest_payment; growth_percentagesign; fourth_quarter; forward_look; facil_dollarsign; dollarsign_million_includ; dollarsign_million_cash; dollarsign_million; credit_facil; covs; cost_structur; continu_grow; capit_structur; borrow_base; asset_sale; approxim_dollarsign_million; adjust_ebitda.

In a further feature, the plurality of digital features comprises, for SEC 8-K documents, senior_secur; rsa; forb; delist_failur; credit_agreement, or five (5) or more of: transfer_list; standard_transfer_list; standard_transfer; senior_secur; senior_note; satisfy_continu_list; satisfy_continu; rule_standard_transfer; rule_standard; rsa; ratio_bk; notic_deli_st_failur; notic_delist; list_rule_standard; item_notic_delist; item_notic; interest_payment; grace_period; forb; failure_satisfi_continu; failure_satisfi; delist_failur_satisfi; delist_failur; credit_agreement_date; credit_agreement; continu_list_rule; continu_list; bk; administer_agent.

In yet another feature, the plurality of digital features comprises, for SEC 10-Q and 10-K documents, substanti_doubt; strateg_altern; regain_complianc; f_token_going; event_default, or five (5) or more of: substanti_doubt_abil; substanti_doubt; strateg_altern; regain_complianc; ratio_bk; f_token_subs; f_token_sa; f_token_going; f_token_forb; f_token_comp; f_filing_delay; event_default; doubt_abil; continu_list; continu_goingconcern; chaptereleven_proceed; chaptereleven_bankruptci; bankruptcy_code; abil_continu_goingconcern.

In still another feature, the plurality of digital features comprises, for press releases, term_loan; rsa; revolv_credit_facil; oper_loss; forb, or five (5) or more of: term_loan; senior_secur; rsa; revolv_credit_facil; revolv_credit; report_form; ratio_bk; princip_amount; previous_disclos; oper_loss; loss_dollarsign_million; loss_dollarsign; forb; financi_advisor; dollarsign_million_relat; credit_facil; covs; compani_current; compani_common_stock; compani_common; capit_structur; bk.

### 2. Structural & Functional Overview

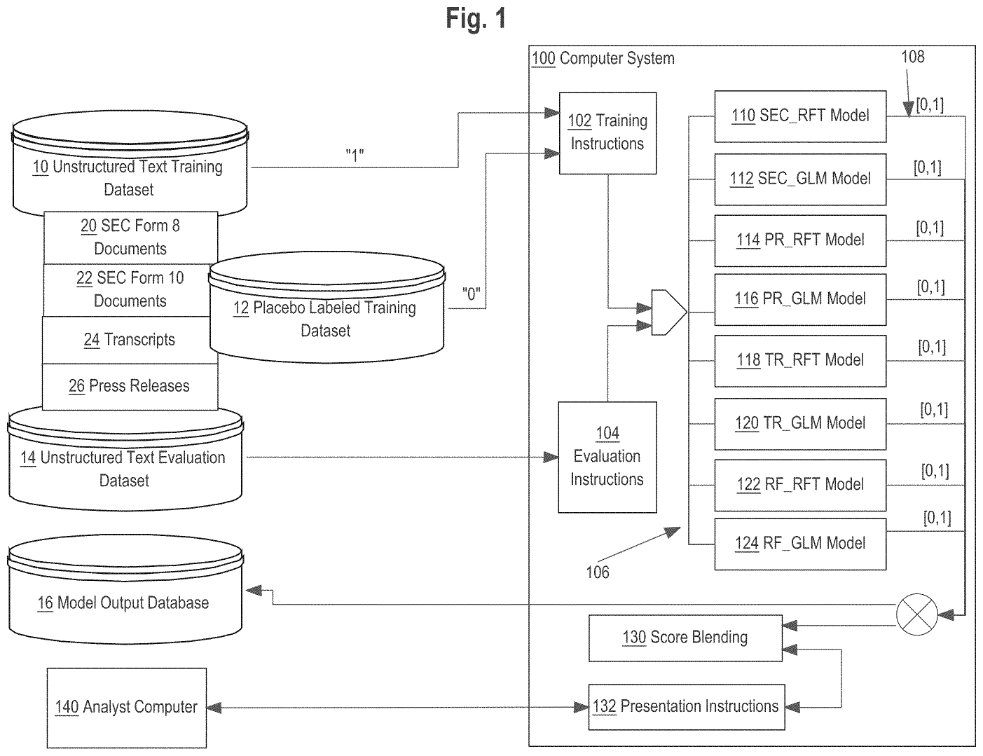

FIG. 1 illustrates a distributed computer system showing the context of use and principal functional elements with which one embodiment could be implemented. In an embodiment, a computer system 100 further comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of machine learning model training and predictive evaluation for large numbers of unstructured text documents. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

In an embodiment, computer system 100 is programmed with training instructions 102, evaluation instructions 104, a score blending unit 130, presentation instructions 132, and a plurality of different machine learning models 110, 112, 114, 116, 118, 120, 122, 124. The distributed system of FIG. 1 further comprises unstructured text training dataset 10, which is coupled as an input to the training instructions 102; placebo labeled training dataset 12, which also is coupled as an input to the training instructions 102. The distributed system of FIG. 1 further comprises unstructured text evaluation dataset 14, which is coupled as an input to the evaluation instructions 104 and a model output database 16. An analyst computer 140, and any number of other networked computers of end users of various classes or categories, may be coupled to computer system 100 via presentation instructions 132.

In an embodiment, each of the unstructured text training dataset 10, placebo labeled training dataset 12, and unstructured text evaluation dataset 14 comprise large stores of electronic documents mainly but not exclusively comprising unstructured text. In an embodiment, the datasets comprise digital electronic copies of documents filed in or obtained from the United States Securities and Exchange Commission, such as Form 8 or Form 10 filings such as Form 8-K, 8-K/A, Form 10-K, NT 10-K, 10-Q, NT 10-Q; transcripts of earnings telephone calls of public companies; and press releases. The SEC documents can be obtained via electronic transfers or data subscriptions to SEC services such as EDGAR. Transcripts can be obtained from public company websites. Press releases can be obtained from sources such as PRNewswire, company websites, or online information services. Other embodiments may use digitally stored unstructured text of types or kinds not enumerated above. Each of the unstructured text training dataset 10, placebo labeled training dataset 12, and unstructured text evaluation dataset 14 can be stored using single, clustered, networked, or cloud-based digital storage devices, databases, flat file systems, or other electronic storage that the computer system 100 can access directly, via a local network, or using network calls, queries, or retrieval requests.

The training instructions 102 are programmed to configure the machine learning models 110, 112, 114, 116, 118, 120, 122, 124 for training, activate training processing, and to select and submit documents or text from the unstructured text training dataset 10 and placebo labeled training dataset 12 to the machine learning models via input paths 106. Training instructions 102 can be programmed as a R script to invoke training modes of the machine learning models 110, 112, 114, 116, 118, 120, 122, 124 and to direct the models to consume documents from datasets 10, 12 in a specified manner.

In an embodiment, machine learning models 110, 112, 114, 116, 118, 120, 122, 124 comprise eight (8) distinct machine learning classifiers. Model 110 is programmed as a tree-based random forest model and trained on SEC documents only. Model 112 is programmed as a generalized linear model and trained on SEC documents only. Model 114 is programmed as a random tree-based random forest model and trained on press release documents only. Model 116 is programmed as a generalized linear model and trained on press release documents only. Model 118 is programmed as a random tree-based random forest model and trained on transcript documents only. Model 120 is programmed as a generalized linear model and trained on transcript documents only. Model 122 is programmed as a random tree-based random forest model and trained, using SEC 10-K and 10-Q documents, using only language associated with risk factors. Thus, the label RF in this disclosure can be an abbreviation for “risk factors”. Model 124 is programmed as a generalized linear model and trained on SEC 10-K and 10-Q documents for risk factors language only. In one aspect, the inventors named herein discovered, in an inventive moment, that separately training and evaluating data against the specific combination of eight (8) machine learning models denoted herein, in combination with blending the classification output of all models, can yield a highly predictive risk index score representative of a risk that a specified entity will change state. In particular, the models described herein, with the document sources and types specified herein, have been found to yield accurate predictions of the risk of an enterprise filing a petition for bankruptcy protection under United States federal law, acting in default of a covenant or other obligation, or failing to receive a going concern designation. Other models, with the same document sources and types or additional sources and types, can be programmed to yield predictions of the risk of an enterprise undergoing other kinds of changes in state, taking other actions, or receiving other designations.

During an evaluation stage, the evaluation instructions 104 may be programmed to obtain documents for evaluation with the machine learning models 110, 112, 114, 116, 118, 120, 122, 124 to output classifications that constitute predictive scores representative of a risk of an enterprise changing state. In an embodiment, individual classification outputs are programmatically transferred to score blending unit 130, which is programmed to form a risk index value for a particular business enterprise based on all the individual classification outputs. Score blending unit 130 can be programmed to combine individual classification outputs by averaging, weighted averaging, or other combinations. In an embodiment, individual classification outputs are programmatically transferred to model output database 16 for persistent storage to facilitate use in analytical reports, graphical visualizations, or other uses.

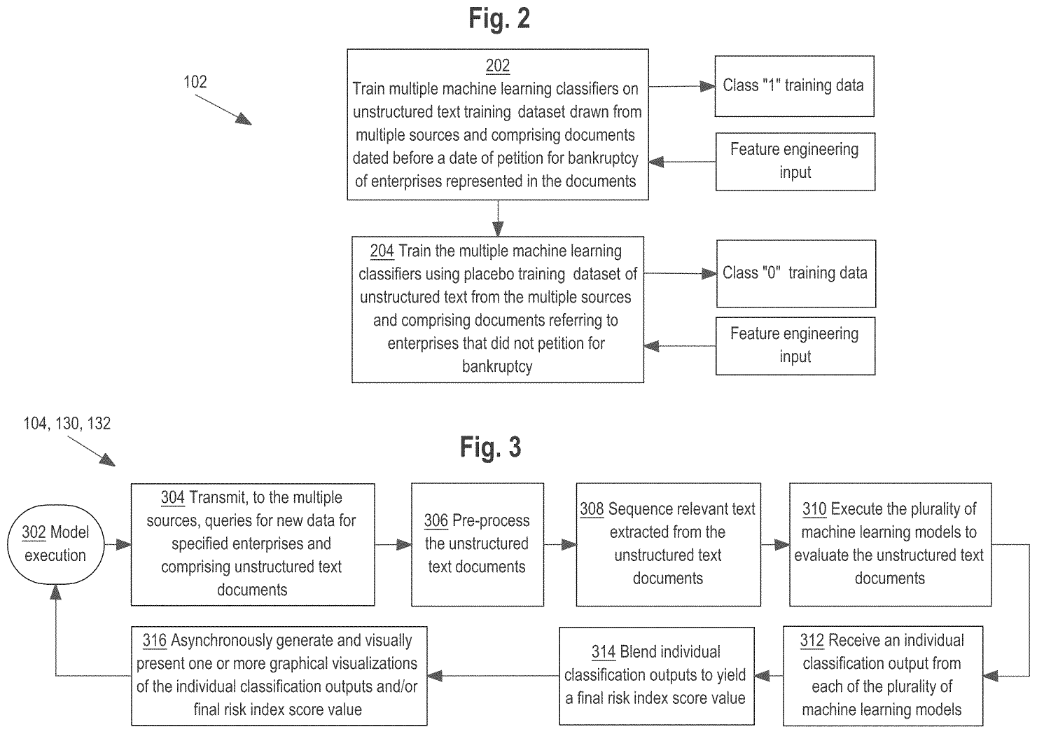

FIG. 2 illustrates a computer-assisted process of training multiple machine learning models. FIG. 2 and each other flow diagram herein is intended as an illustration at the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs.

FIG. 2 may represent a portion of the instructions that are programmed as part of training instructions 102 (FIG. 1). Furthermore, FIG. 2 and FIG. 3, collectively, can represent algorithms that can be programmed to implement a computer-implemented method of automatically processing digitally stored unstructured text concerning a plurality of entities and automatically generating a prediction of a risk of a change in state of one or more of the entities, the method comprising, executed using one or more computing devices: compiling a training dataset from two or more distinct sources of sets of unstructured digitally stored electronic text documents; training a plurality of machine learning classifiers using the training dataset, the plurality of machine learning classifiers comprising a random tree-based random forest model corresponding to each of the two or more distinct sets and a generalized linear model corresponding to each of the two or more distinct sets, each of the plurality of machine learning classifiers being configured to classify input documents based upon a plurality of digital features and to output a prediction value; obtaining an evaluation dataset from the two or more distinct sources, the evaluation dataset comprising other unstructured digitally stored electronic text documents that are not in the training dataset; executing the plurality of machine learning classifiers thereby evaluating the evaluation dataset and outputting a plurality of individual classification outputs; blending the plurality of individual classification outputs to form a final risk index score value; programmatically generating a plurality of user interface presentation instructions which, when rendered using a computer display device, cause visually displaying one or more graphical visualizations of the individual classification outputs and/or the final risk index score value.

In an embodiment, at block 202, training instructions 102 are programmed to train multiple machine learning classifiers on an unstructured text training dataset drawn from multiple sources and comprising documents dated before a date of a particular kind of change in state, action, or designation of enterprises represented in the document. For example, block 202 comprises instructions to train each the machine learning models 110, 112, 114, 116, 118, 120, 122, 124 (FIG. 1) and the unstructured text training dataset 10 (FIG. 1) may be used.

In an embodiment, block 202 is programmed to cause training based upon six months of text data from the four (4) sources identified in connection with FIG. 1. Since the documents in unstructured text training dataset 10 are associated with entities or enterprises that eventually filed a petition for bankruptcy, changed state in another way, took a specified action or received a specified designation, during training, documents in the unstructured text training dataset are labeled or classified with values of “1” meaning that their contents are predictive of a high risk of filing a petition for bankruptcy. Consequently, the unstructured text training dataset used at block 202 will bias the machine learning models 110, 112, 114, 116, 118, 120, 122, 124 toward a prediction of bankruptcy filing, changing state in another way, taking a specified action or receiving a specified designation. Training also will inherently associate documents and weights or scores with enterprises named in the documents. Training data may include documents that identify enterprises and dates of actual filings of petitions for bankruptcy or actions of default.

Block 202 also may comprise receiving feature engineering input via the training instructions 102 and/or from separate configuration instructions or files. Feature engineering input provides a way to identify, among all attributes or features represented in the unstructured text training dataset, which features are more predictive of a bankruptcy petition filing, changing state in another way, taking a specified action or receiving a specified designation. For example, feature engineering input can specify tokens, keywords, or other text in the unstructured text training dataset with weight values that bias those tokens, keywords, or other text higher or lower in predictive value. In one implementation, the following feature space sizes and training sizes were used, for six months of 8-Ks, press releases, transcripts, 10-Qs and eighteen months of 10-Ks:

SEC_GLM model and SEC_RFT model— feature space 2,675, training size 2,731;

RF_GLM model and RF_RFT model—feature space 27,757, training size 1,625;

TR_GLM model and TR_RFT model—feature space 11,533, training size 809;

PR_GLM model and PR_RFT model—feature space 1,093, training size 3,985.

In the same implementation, the model performance shown in TABLE 1 was observed:

TABLE 1
Performance Metric Summary

| | | Training | Training | | |
|---|---|---|---|---|---|
| Model | Documents | Size (=1) | Accuracy | F1 Score | Threshold |
| SEC_GLM | 8-K, 8-K/A | 316 | 93% | 91% | 0.30 |
| SEC_RFT | 8-K, 8-K/A | 316 | 94% | 82% | 0.60 |
| RF_GLM | 10-K, NT 10- | 309 | 93% | 90% | 0.39 |
| | K, 10-Q, NT | | | | |
| | 10-Q | | | | |
| RF_RFT | 10-K, NT 10- | 309 | 90% | 90% | 0.40 |
| | K, 10-Q, NT | | | | |
| | 10-Q | | | | |
| TR_GLM | Transcripts | 182 | 94% | 94% | 0.88 |
| TR_RFT | Transcripts | 182 | 85% | 85% | 0.62 |
| PR_GLM | Press releases | 485 | 82% | 76% | 0.32 |
| PR_RFT | Press releases | 485 | 90% | 72% | 0.43 |

At block 204, in an embodiment, the training instructions 102 are programmed to train the multiple machine learning models using a placebo training dataset of unstructured text from the multiple sources and comprising documents referring to enterprises that did not petition for bankruptcy, change state in another way, take a specified action or receive a specified designation. In an embodiment, the placebo training dataset references enterprises that have been selected randomly or using pseudo-random techniques, with human review of the documents to ensure they are associated correctly with entities that did not petition. For example, placebo labeled training dataset 12 of FIG. 1 can be used, with training instructions that are configured to label dataset values as “0” or predictive of a low risk of a future bankruptcy filing, changing state in another way, taking a specified action or receiving a specified designation. As with block 202, block 204 can comprise receiving feature engineering input to bias the training process toward or away from specified features in the placebo labeled training dataset. Curation of the dataset is likely to be needed given the significance of bias toward “0” that the dataset can cause.

FIG. 3 illustrates a computer-implemented process of evaluating or executing multiple machine learning models in real time based upon newly obtained unstructured text documents. FIG. 3 can represent aspects of implementing instructions 104, 130, 132 of FIG. 1. In an embodiment, FIG. 3 represents a model execution process as denoted by block 302. At block 304, the process is programmed to transmit, to the multiple data sources of FIG. 1, FIG. 2, queries to retrieve new data for specified enterprises and comprising unstructured text documents. In some embodiments, queries at block 304 identify an enterprise by ticker symbol, a normalized enterprise name, or another identifier that is likely to appear in relevant documents. In response, the process receives a result set of documents such as SEC filings, call transcripts, and press releases. The process of FIG. 3 can be scheduled to execute on a daily basis, to retrieve dozens to thousands of documents for analysis. The process of FIG. 3 can be scheduled to retrieve documents for a specified list of enterprises based upon company names, aliases, or associated entity names.

At block 306, the process is programmed to pre-process the unstructured text documents. Pre-processing can include, for example, truncating or removing irrelevant blocks of text, advertisements, graphics, or other elements with little substantive content or predictive value.

At block 308, the process is programmed to sequence relevant text that has been extracted from the unstructured text documents. Sequencing can be programmed, in one embodiment, as follows. Preprocessed text from six or eighteen months of relevant text is organized in chronological order for each company. This collective text is then pruned for suitable vocabulary, meaning removing rare words such as proper nouns and common stop words. A document term matrix is constructed using the resultant data. Word frequency values are calculated for the timeframe of six or eighteen months, and the word frequency values are used as features for the machine learning model.

At block 310, the process is programmed to submit relevant text from the unstructured text documents, after pre-processing and sequencing, to the plurality of machine learning models, such as the models of FIG. 1. Evaluation of the models produces an automatic machine classification output from each model. At block 312, the process is programmed to receive a classification output from each of the plurality of machine learning models. Output may be received the models writing to a logical standard output, by a programmatic call, using an API, or other means.

At block 314, the individual classification outputs are blended to yield a final risk index score. In an embodiment, the risk index is a floating-point value between 0 and 1 in which 1 represents the highest risk that a specified enterprise will file a bankruptcy petition, change state in another way, take a specified action or receive a specified designation. Individual classification outputs can be combined by averaging, weighted averaging, or other combinations. In an embodiment, the individual classification outputs and the final risk index score are programmatically transferred to the model output database 16 for persistent storage to facilitate use in analytical reports, graphical visualizations, or other uses.

At block 316, the process of FIG. 3 is programmed to asynchronously generate and visually present one or more graphical visualizations of the classification output and/or final risk index score. “Asynchronously,” in this context, means that the process may be programmed to generate and present multiple different graphical visualizations at different times, on demand, or in response to a request. For example, the process of FIG. 3 could be integrated into an interactive program with a user interface by which the analyst computer 120 (FIG. 1) or other computers of end users can request different kinds of visualizations. In an embodiment, block 316 can be programmed to generate code capable of rendering in a browser, using a display driver, using a graphics library, or using other programs to cause writing, outputting, or otherwise presenting graphical images, charts, tables, plots, or other representations of the individual classification outputs, and/or the final risk index score, in computer display devices.

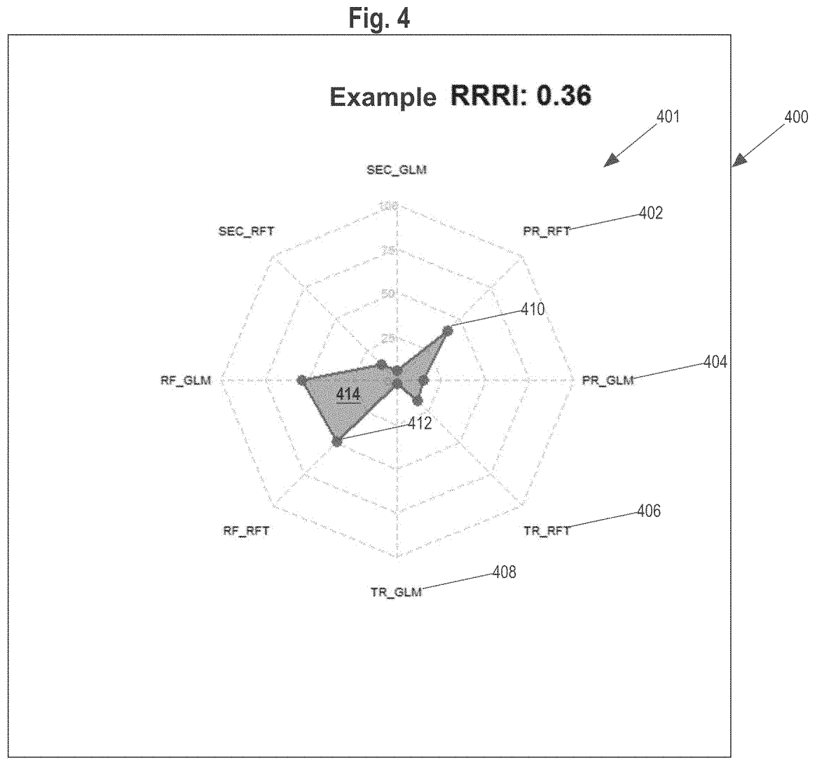

FIG. 4 illustrates an example computer-generated graphical visualization of multiple predicted output values from multiple machine learning models relating to a particular enterprise. In one embodiment, a computer display device 400 comprises a graphical user interface in which a radar plot 401 is rendered and displayed. In an embodiment, radar plot 401 comprises a plurality of elongated, radially extending, equally spaced-apart axes, each axis corresponding to one of the machine learning models of FIG. 1. For example, labels 402, 404 correspond to models 114, 116 of FIG. 1, labels 406, 408 correspond to models 118, 120, and so forth. On each axis, the radar plot 401 comprises a graphical point that corresponds to the individual machine learning model predictive output from the corresponding model. For example, point 410 represents the magnitude of the predictive output of model 114 since that point is on the axis bearing the label 402. Similarly, point 412 represents a magnitude of the predictive output of the RF_RFT model 122 of FIG. 1.

Lines or edges join points on adjacent axes to form an irregular polygon 414. The polygon 414 can be shaded, colored, or otherwise rendered in a distinctive manner. For many viewers, the effect of polygon 414 is to rapidly communicate which models among the plurality of machine learning models had the greatest impact on the final risk index value. Thus, the example of FIG. 4 for a final risk index value of “0.36” suggests that the RF_GLM and RF_RFT models generated a relatively high forecast of bankruptcy filing, with values of about 0.50 each; the PR_RFT was slightly less predictive; and the SEC_RFT, SEC_GLM, PR_GLM, TR_RFT, and TR_GLM models all had low predictive values and tended to push the overall score lower. The polygon 414 therefore can assist the analyst computer 120 in determining which of the document sources to inspect more closely or to trust more or less.

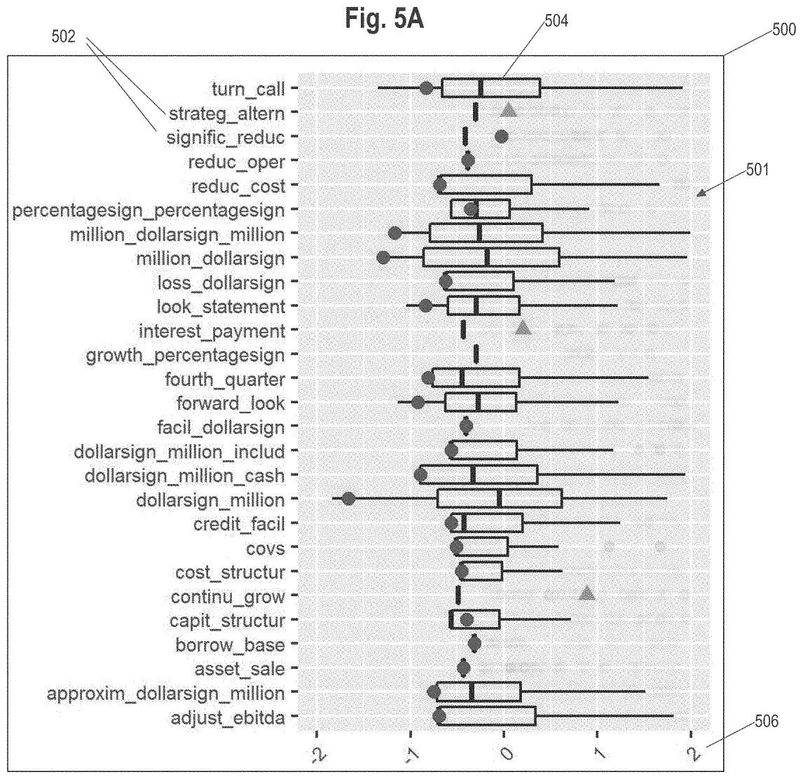

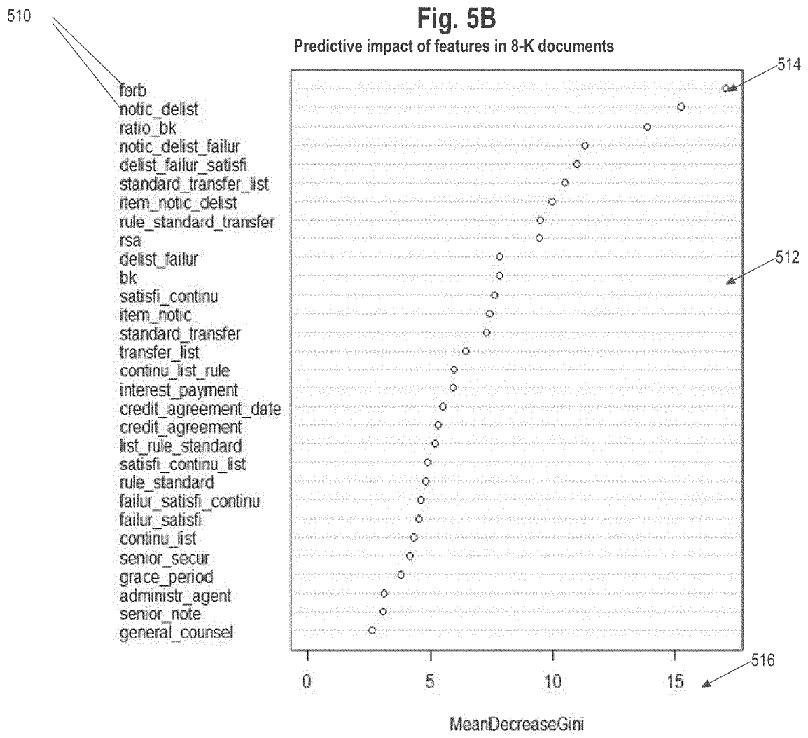

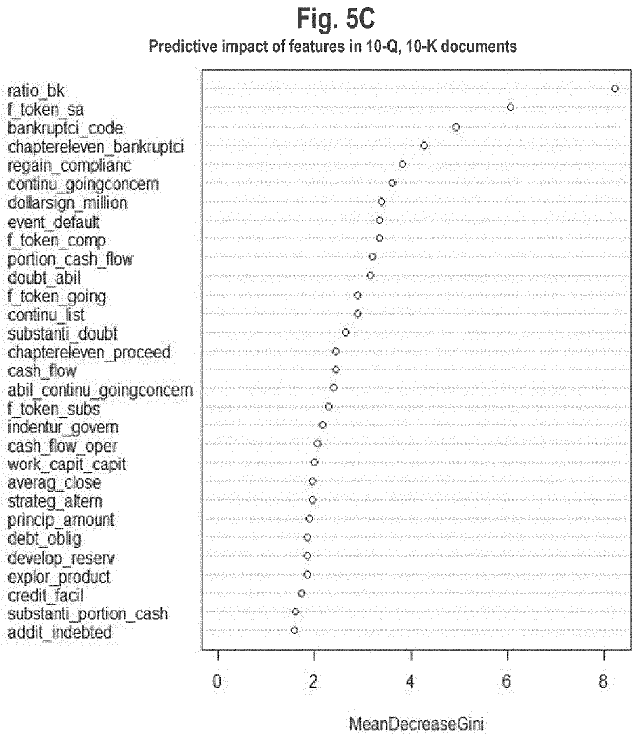

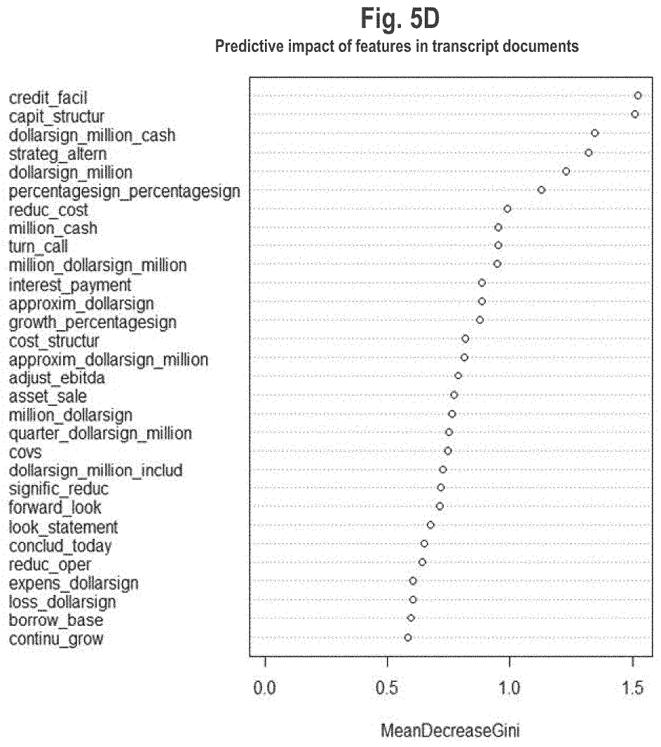

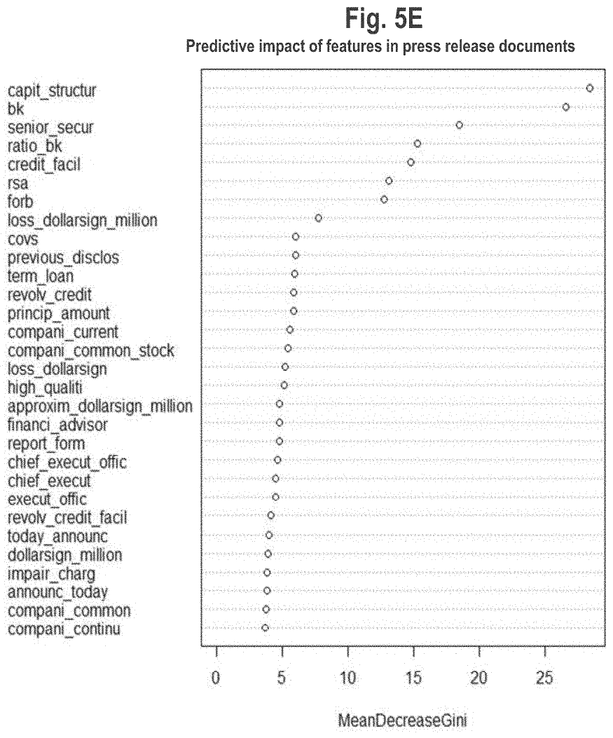

FIG. 5A illustrates a set of highly predictive features derived from a large number of call transcript documents, in association with computer-generated box plot graphics that associate the features with an axis representing a magnitude of predictive value. In an embodiment, the presentation instructions 130 may be programmed to cause displaying, on a computer display device 500, a box plot 501 comprising a plurality of feature labels 502, each of the feature labels being displayed near a corresponding boxplot graphic 504 that correlates to an x-axis 506 specifying values of a magnitude of predictive value. Feature labels 502 correspond to features of a training dataset and/or evaluation dataset that have been determined, by discovery through experimentation in an inventive moment, to be most predictive of a change in a state of an enterprise, such as the filing of a bankruptcy petition, changing state in another way, taking a specified action or receiving a specified designation.

In an embodiment, features correspond to one or more tokens or words in the datasets. Further, feature labels 502 can refer to or suggest an association with a plurality of related tokens or words that are deemed to constitute the same feature. In the example of FIG. 5, feature labels 502 include “strateg_altern” and “signific_reduc”. In one implementation, the feature label “strateg_altern” can mean that the training dataset and/or evaluation dataset include sentences, paragraphs, or other units of text referring or relating to “exploring strategic alternatives,” “investigating strategic options,” or similar phrases. In the same or a different implementation, the feature label “signfic_reduc” can represent tokens or words in the training dataset and/or evaluation dataset mentioning “significant reduction in costs,” “significant reduction in personnel,” “significant reduction in sales,” and so forth. Thus, each of the feature labels 502 can correspond to a different combination of tokens or words in the training dataset and/or evaluation dataset, the semantics of each combination being suggested by the feature label. Examples of other feature values that can be predictive of high risk include references to: proxies; change in management; risk factors; distributed debt; grace period; covenants; breach of covenants; forbearance; revising guidance down; withdrawing estimates; leverage ratios. Examples of specific language in documents that can correspond to the foregoing features and can result in training the machine learning models to higher risk predictions include: “Bankruptcy or Receivership”, “Triggering Events That Accelerate or Increase a Direct Financial Obligation or an Obligation under an Off-Balance Sheet Arrangement”, “Notice of Delisting or Failure to Satisfy a Continued Listing Rule or Standard; Transfer of Listing”, “Departure of Directors or Certain Officers; Election of Directors; Appointment of Certain Officers” and so forth.

As stated in other sections herein and illustrated in block 314, the individual classification outputs from the plurality of machine learning models for different document types are blended to yield a final risk index score, which can be a floating-point value from 0 to 1, where 1 is the highest risk that a specified enterprise will file for bankruptcy. Through thorough empirical and/or statistical analysis, the inventors have determined that it is highly unlikely or improbable for an enterprise with an index score of less than 0.54 to default or file for bankruptcy. Concurrently, it is determined that a risk index score in the range of 0.54 to 1 would indicate significant events or matters in an enterprise that can ultimately lead to the filing of a bankruptcy petition, changing state in another way, taking a specified action or receiving a specified designation.

Outputs of the model or the plurality of machine learning models comprise feature labels that correspond to features of a training dataset and/or evaluation dataset that have been determined, by discovery through experimentation in an inventive moment, to be most predictive of a change in a state of an enterprise, taking a specified action or receiving a specified designation. This is visualized in FIG. 5A. Analysis of the plot of FIG. 5A can indicate what features or word tokens from this document type of the specified enterprise contribute to the risk index score. As an example, a high predictive impact of the tokens strateg_altern; loss_dollarsign; asset_sale in FIG. 5A can indicate an event for the specified enterprise where it is experiencing significant loss of money, dealing with a review of strategic alternatives, and looking at an asset_sale as a result. These are often significant events that can be experienced by enterprises which file for bankruptcy. By interpreting such plots for the specified enterprise, the factors or lack thereof that contribute to a index score will be apparent. Furthermore, the risk index score can be linked or associated with certain events that can trigger a significant change of state in an enterprise like filing for bankruptcy or other crucial market-mover events like M&A, or management change.

In one embodiment, the inventors discovered, driven by experimentation, in an inventive moment, that the most predictive features of the datasets identified in this disclosure, for call transcripts, include: credit_facil; strateg_altern; significs_reduc; covs; asset_sale; These feature labels suggest an association with a plurality of related tokens or words that are deemed to constitute the same feature. These tokens are used in a variety of phrases various across transcripts, examples of which are highlighted below—
credit_facil—cash on hand available under our revolving credit facility; millions in undrawn credit facilities
strateg_altern—consider strategic alternatives; review of strategic options and alternatives
significs_reduc—significant reductions in overheads; significant reduction in sales
covs—debt covenants; financial covenants
asset_sale—noncore asset sales; lower gains on asset sale

In one embodiment, the inventors discovered, driven by experimentation, in an inventive moment, that the most predictive features of the datasets identified in this disclosure, for SEC 8-K documents, include five (5) or more of: senior_secur; rsa; forb; delist_failur; credit_agreement. These feature labels suggest an association with a plurality of related tokens or words that are deemed to constitute the same feature. These tokens are used in a variety of phrases various across SEC 8-K, examples of which are highlighted below—
senior_secur—convertible senior notes due; exchange of senior secured notes
rsa—company entered into a restructuring support agreement (the RSA)
forb—amendment to the forbearance agreement; forbearance
delist_failur—notice of delisting and failure to satisfy listing rule
credit_agreement—restated credit agreement; amended credit agreement provides a revolving line of credit

In one embodiment, the inventors discovered, driven by experimentation, in an inventive moment, that the most predictive features of the datasets identified in this disclosure, for SEC 10-Q and 10-K documents, include five (5) or more of: substanti_doubt; strateg_altern; regain_complianc; f_token_going; event_default; These feature labels suggest an association with a plurality of related tokens or words that are deemed to constitute the same feature. These tokens are used in a variety of phrases various across SEC 10-Q and 10-K, examples of which are highlighted below—
substanti_doubt—raise substantial doubt about the company; substantial doubts exist regarding our ability to continue
strateg_altern—consider strategic alternatives; review of strategic options and alternatives
regain_complianc—regain compliance with the bid requirement; company's ability to regain compliance with its debt covenants
f_token_going—indicates the frequency occurrence of word “going concern” in the text
event_default—failure to comply could result in event of default, borrower's event of default

In one embodiment, the inventors discovered, driven by experimentation, in an inventive moment, that the most predictive features of the datasets identified in this disclosure, for press releases, include five (5) or more of: term_loan; rsa; revolv_credit_facil; oper_loss; forb; These feature labels suggest an association with a plurality of related tokens or words that are deemed to constitute the same feature. These tokens are used in a variety of phrases various across press releases, examples of which are highlighted below—
term_loan—first lien term loan; senior secured term loan; uncertainties relating to the term loan
rsa—company entered into a restructuring support agreement (the RSA)
revolv_credit_facil—repay borrowings under its revolving credit facility
oper_loss—increase in operating losses; adjusted operating (loss)
forb—amendment to the forbearance agreement; forbearance

FIG. 5B, FIG. 5C, FIG. 5D, FIG. 5E each illustrate the predictive impact of specified features of specified kinds of documents including 8-K, 10-K, press releases, and transcripts, respectively, for the random forest models of FIG. 1. Each of FIG. 5B, FIG. 5C, FIG. 5D, FIG. 5E comprises a graph in which a plurality of feature labels are shown in the Y axis and values for a mean decrease in gini are shown in the X axis. Mean decrease in gini is the average (mean) of a variable's total decrease in node impurity, weighted by the proportion of samples reaching that node in each individual decision tree in the random forest. Referring to FIG. 5B as an example, feature labels 510 are shown as part of a plot 512 in which individual points 514 correspond to the feature labels and reflect magnitude values of axis 516. Each of FIG. 5B, FIG. 5C, FIG. 5D, FIG. 5E has the same form which different feature labels and values as appropriate for the underlying data source. The data shown in each of FIG. 5B, FIG. 5C, FIG. 5D, FIG. 5E, and the enumeration of features above, may be used as part of feature engineering of the models of FIG. 1.

The architecture, processes, data sources, and feature engineering described herein provide an effective technical solution to the problem of how to predict a change in state of an enterprise based upon a volume of unstructured data that is beyond the human capacity to comprehend. Significantly, the processes herein do not use or rely on any structured data, such as financial statements or records of enterprise fundamentals. The feature engineering disclosed herein primarily focuses on measuring issues such as higher leverage in terms of equity or debt in comparison to capital or revenue, higher asset volatility, and lower growth rate, by quantifying numerous language tokens that experimentation and discovery have shown to be predictive of the high or low risk of a petition. Feature engineering can focus on particular features that are found to be predictive of bankruptcy petitions, changing state in another way, taking a specified action or receiving a specified designation, or other similar changes or actions, and embodiments are not limited to any particular kind of change or kind of filing that an enterprise performs.

The following case study illustrates the effectiveness and utility of the machine learning architecture and processes disclosed herein. In this section, a real enterprise and real data values are discussed, but certain dates and names have been changed to ensure that the description is considered generalized; for example, the enterprise is termed “Company C” although its true name is different. On September 14 of Year 1, Company C published Form 10-Q, which mentioned the Paycheck Protection Program (PPP) and noted that an “event of default” could cause loan forgiveness ineligibility or trigger repayment. On September 11 of Year 1, Company C published a press release which referred to cash equivalents under a “credit facility.” On December 10 of Year 1, Company C published a press release concerning third-quarter financial results that referred to the credit facility, and “strategic alternatives,” “restructuring,” “ability to continue as a going concern,” and similar terms. On December 11 of Year 1, Company C had a final risk index score, using the approach of this disclosure, of 0.29. On December 12, Company C filed Form 8-K to state quarterly earnings. The final risk index score was recalculated using the techniques herein, based on the recent filing, and changed to 0.33. On December 15, Company C filed Form 10-K and that document stated that the company had “determined that there is a substantial doubt about our ability to continue as a going concern,” in four (4) instances. The final risk index score was recalculated again and worsened to 0.68. On January 7 of Year 2, Company C published Form 8-K which referred to a Term Loan Facility and Events of Default relating to that loan, a secured vendor program agreement with various events of default, and other credit facility information including a notice of events of default. On January 8 of Year 2, Company C filed Form 8-K and mentioned “Triggering Events that Increase a Direct Financial Obligation.” The final risk index score changed to 0.71. On January 14 of Year 2, Company C issued a press release announcing a Chapter 11 bankruptcy filing, moving its final risk index score to 1.00.

### 3. Implementation Example— Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

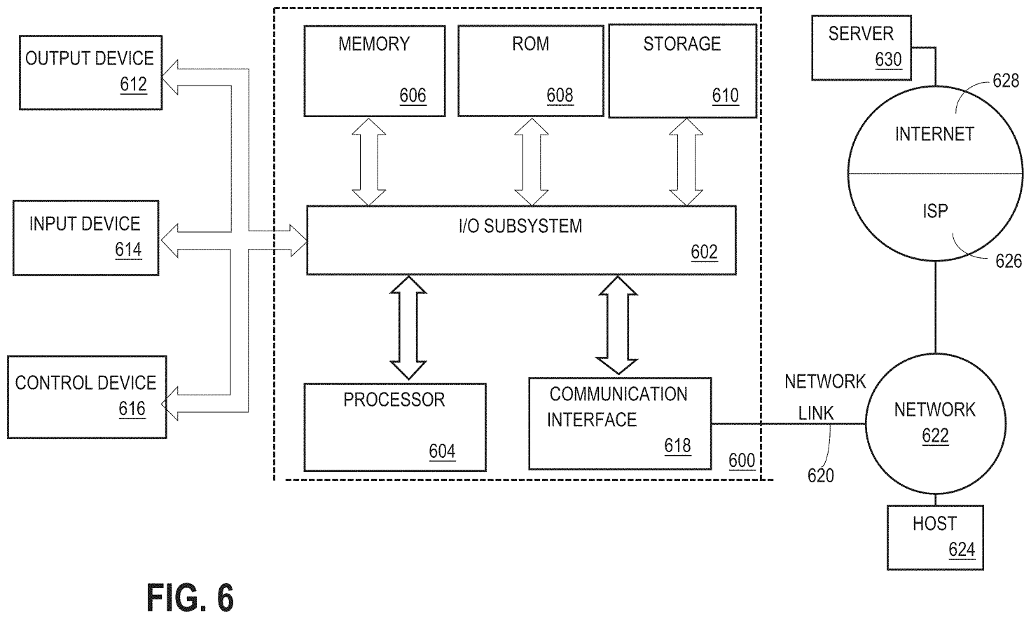

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or no SQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A computer-implemented method of automatically processing digitally stored unstructured text concerning a plurality of entities and automatically generating a prediction of a risk of a change in state of one or more of the entities, the method comprising, executed using one or more computing devices:
compiling a training dataset from two or more distinct sources of sets of unstructured digitally stored electronic text documents;
training a plurality of machine learning classifiers using the training dataset, the plurality of machine learning classifiers comprising a tree-based random forest model corresponding to each of the two or more distinct sets and a generalized linear model corresponding to each of the two or more distinct sets, each of the plurality of machine learning classifiers being configured to classify input documents based upon a plurality of digital features and to output a prediction value;
the plurality of machine learning classifiers comprising eight (8) machine learning models consisting of a tree-based random forest model (RFT model) configured to classify US Securities and Exchange Commission (SEC) documents of a first type; a generalized linear model (GLM) configured to classify the US Securities and Exchange Commission (SEC) documents of the first type; an RFT model configured to classify press releases; a GLM model configured to classify the press releases; an RFT model configured to classify call transcripts; a GLM model configured to classify the call transcripts; an RFT model configured to classify SEC documents of a second type; a GLM model configured to classify the SEC documents of the second type;
obtaining an evaluation dataset from the two or more distinct sources, the evaluation dataset comprising other unstructured digitally stored electronic text documents that are not in the training dataset;
executing the plurality of machine learning classifiers thereby evaluating the evaluation dataset and outputting a plurality of individual classification outputs;
blending the plurality of individual classification outputs to form a final risk index score value;
programmatically generating a plurality of user interface presentation instructions which, when rendered using a computer display device, cause visually displaying one or more graphical visualizations of the individual classification outputs and/or the final risk index score value.

2. (canceled)

3. The method of claim 1, further comprising training the plurality of machine learning classifiers using a placebo labeled training dataset comprising a plurality of digital electronic documents all associated with one of: enterprises that did not file a petition for bankruptcy, enterprises that acted in default of a covenant or other obligation, enterprises that failed to receive a going concern designation.

4. The method of claim 1, further comprising programmatically generating the plurality of user interface presentation instructions which, when rendered using a computer display device, cause visually displaying a radar plot, the individual classification outputs being displayed as a plurality of different points on different axes of the radar plot.

5. The method of claim 4, further comprising programmatically generating the plurality of user interface presentation instructions which, when rendered using a computer display device, cause visually displaying a polygon having sides that join the points.

6. The method of claim 1, the risk of a change in state of one or more of the entities comprising one of: a risk of an enterprise filing a petition for bankruptcy, acting in default of a covenant or other obligation, and failing to receive a going concern designation.

7. The method of claim 1, the plurality of digital features comprising, for call transcripts, credit_facil; strateg_altern; significs_reduc; covs; asset_sale.

8. The method of claim 1, the plurality of digital features comprising, for call transcripts, five (5) or more of: turn_call; strateg_altern; significs_reduc; reduc_oper; reduc_cost; percentagesign_percentagesign; million_dollarsign_million; million_dollarsign; loss_dollarsign; look_statement; interest_payment; growth_percentagesign; fourth_quarter; forward_look; facil_dollarsign; dollarsign_million_includ; dollarsign_million_cash; dollarsign_million; credit_facil; covs; cost_structur; continu_grow; capit_structur; borrow_base; asset_sale; approxim_dollarsign_million; adjust_ebitda.

9. The method of claim 1, the plurality of digital features comprising, for SEC 8-K documents, senior_secur; rsa; forb; delist_failur; credit_agreement.

10. The method of claim 1, the plurality of digital features comprising, for SEC 8-K documents, five (5) or more of: transfer_list; standard_transfer_list; standard_transfer; senior_secur; senior_note; satisfy_continu_list; satisfy_continu; rule_standard_transfer; rule_standard; rsa; ratio_bk; notic_delist_failur; notic_delist; list_rule_standard; item_notic_delist; item_notic; interest_payment; grace_period; forb; failure_satisfi_continu; failure_satisfi; delist_failur_satisfi; delist_failur; credit_agreement_date; credit_agreement; continu_list_rule; continu_list; bk; administer_agent.

11. The method of claim 1, the plurality of digital features comprising, for SEC 10-Q and 10-K documents, substanti_doubt; strateg_altern; regain_complianc; f_token_going; event_default.

12. The method of claim 1, the plurality of digital features comprising, for SEC 10-Q and 10-K documents, five (5) or more of: substanti_doubt_abil; substanti_doubt; strateg_altern; regain_complianc; ratio_bk; f_token_subs; f_token_sa; f_token_going; f_token_forb; f_token_comp; f_filing_delay; event_default; doubt_abil; continu_list; continu_goingconcern; chaptereleven_proceed; chaptereleven_bankruptci; bankruptcy_code; abil_continu_goingconcern.

13. The method of claim 1, the plurality of digital features comprising, for press releases, term_loan; rsa; revolv_credit_facil; oper_loss; forb.

14. The method of claim 1, the plurality of digital features comprising, for press releases, include five (5) or more of: term_loan; senior_secur; rsa; revolv_credit_facil; revolv_credit; report_form; ratio_bk; princip_amount; previous_disclos; oper_loss; loss_dollarsign_million; loss_dollarsign; forb; financi_advisor; dollarsign_million_relat; credit_facil; covs; compani_current; compani_common_stock; compani_common; capit_structur; bk.

15. One or more non-transitory computer-readable storage media storing one or more sequences of instructions which when executed using one or more processors cause the one or more processors to execute automatically processing digitally stored unstructured text concerning a plurality of entities and automatically generating a prediction of a risk of a change in state of one or more of the entities by:
compiling a training dataset from two or more distinct sources of sets of unstructured digitally stored electronic text documents;
training a plurality of machine learning classifiers using the training dataset, the plurality of machine learning classifiers comprising a random tree-based random forest model corresponding to each of the two or more distinct sets and a generalized linear model corresponding to each of the two or more distinct sets, each of the plurality of machine learning classifiers being configured to classify input documents based upon a plurality of digital features and to output a prediction value;
the plurality of machine learning classifiers comprising eight (8) machine learning models consisting of a tree-based random forest model (RFT model) configured to classify US Securities and Exchange Commission (SEC) documents of a first type; a generalized linear model (GLM) configured to classify the US Securities and Exchange Commission (SEC) documents of the first type; an RFT model configured to classify press releases; a GLM model configured to classify the press releases; an RFT model configured to classify call transcripts; a GLM model configured to classify the call transcripts; an RFT model configured to classify SEC documents of a second type; a GLM model configured to classify the SEC documents of the second type;
obtaining an evaluation dataset from the two or more distinct sources, the evaluation dataset comprising other unstructured digitally stored electronic text documents that are not in the training dataset;
executing the plurality of machine learning classifiers thereby evaluating the evaluation dataset and outputting a plurality of individual classification outputs;
blending the plurality of individual classification outputs to form a final risk index score value;
programmatically generating a plurality of user interface presentation instructions which, when rendered using a computer display device, cause visually displaying one or more graphical visualizations of the individual classification outputs and/or the final risk index score value.

16. (canceled)

17. The non-transitory computer-readable storage media of claim 15,
further comprising training the plurality of machine learning classifiers using a placebo labeled training dataset comprising a plurality of digital electronic documents all associated with one of: enterprises that did not file a petition for bankruptcy, enterprises that acted in default of a covenant or other obligation, enterprises that failed to receive a going concern designation.

18. The non-transitory computer-readable storage media of claim 15, further comprising programmatically generating the plurality of user interface presentation instructions which, when rendered using a computer display device, cause visually displaying a radar plot, the individual classification outputs being displayed as a plurality of different points on different axes of the radar plot.

19. The non-transitory computer-readable storage media of claim 18, further comprising programmatically generating the plurality of user interface presentation instructions which, when rendered using a computer display device, cause visually displaying a polygon having sides that join the points.

20. The non-transitory computer-readable storage media of claim 15, the risk of a change in state of one or more of the entities comprising one of: a risk of an enterprise filing a petition for bankruptcy, acting in default of a covenant or other obligation, and failing to receive a going concern designation.

21. The non-transitory computer-readable storage media of claim 15, the plurality of digital features comprising, for call transcripts, credit_facil; strateg_altern; significs_reduc; covs; asset_sale.

22. The non-transitory computer-readable storage media of claim 15, the plurality of digital features comprising, for call transcripts, five (5) or more of: turn_call; strateg_altern; significs_reduc; reduc_oper; reduc_cost; percentagesign_percentagesign; million_dollarsign_million; million_dollarsign; loss_dollarsign; look_statement; interest_payment; growth_percentagesign; fourth_quarter; forward_look; facil_dollarsign; dollarsign_million_includ; dollarsign_million_cash; dollarsign_million; credit_facil; covs; cost_structur; continu_grow; capit_structur; borrow_base; asset_sale; approxim_dollarsign_million; adjust_ebitda.

23. The non-transitory computer-readable storage media of claim 15, the plurality of digital features comprising, for SEC 8-K documents, senior_secur; rsa; forb; delist_failur; credit_agreement.

24. The non-transitory computer-readable storage media of claim 15, the plurality of digital features comprising, for SEC 8-K documents, five (5) or more of: transfer_list; standard_transfer_list; standard_transfer; senior_secur; senior_note; satisfy_continu_list; satisfy_continu; rule_standard_transfer; rule_standard; rsa; ratio_bk; notic_delist_failur; notic_delist; list_rule_standard; item_notic_delist; item_notic; interest_payment; grace_period; forb; failure_satisfi_continu; failure_satisfi; delist_failur_satisfi; delist_failur; credit_agreement_date; credit_agreement; continu_list_rule; continu_list; bk; administer_agent.

25. The non-transitory computer-readable storage media of claim 15, the plurality of digital features comprising, for SEC 10-Q and 10-K documents, substanti_doubt; strateg_altern; regain_complianc; f_token_going; event_default.

26. The non-transitory computer-readable storage media of claim 15, the plurality of digital features comprising, for SEC 10-Q and 10-K documents, five (5) or more of: substanti_doubt_abil; substanti_doubt; strateg_altern; regain_complianc; ratio_bk; f_token_subs; f_token_sa; f_token_going; f_token_forb; f_token_comp; f_filing_delay; event_default; doubt_abil; continu_list; continu_goingconcern; chaptereleven_proceed; chaptereleven_bankruptci; bankruptcy_code; abil_continu_goingconcern.

27. The non-transitory computer-readable storage media of claim 15, the plurality of digital features comprising, for press releases, term_loan; rsa; revolv_credit_facil; oper_loss; forb.

28. The non-transitory computer-readable storage media of claim 15, the plurality of digital features comprising, for press releases, include five (5) or more of: term_loan; senior_secur; rsa; revolv_credit_facil; revolv_credit; report_form; ratio_bk; princip_amount; previous_disclos; oper_loss; loss_dollarsign_million; loss_dollarsign; forb; financi_advisor; dollarsign_million_relat; credit_facil; covs; compani_current; compani_common_stock; compani_common; capit_structur; bk.

29. The non-transitory computer-readable storage media of claim 15, the plurality of machine learning classifiers being configured to classify US Securities and Exchange Commission (SEC) documents of one or more types, press releases, call transcripts.

30. The method of claim 1, the plurality of machine learning classifiers being configured to classify US Securities and Exchange Commission (SEC) documents of one or more types, press releases, call transcripts.
